(19) United States
(12) Patent Application Publication
(10) Pub. No.: US 2014/0114218 A1
(43) Pub. Date: Apr. 24, 2014

(54) Method of providing a leg crutch

(71) Applicant: Benton Frederick Baugh, Houston, TX (US)

(72) Inventor: Benton Frederick Baugh, Houston, TX (US)

(21) Appl. No.: 13/656,716

(22) Filed: Oct. 21, 2012

(51) Int. Cl. A61H 1/02

(52) U.S. Cl. 601/34

(57) ABSTRACT

The method of providing leg support for an ambulatory patient comprising
providing a seat area to engage the crotch of the ambulatory patient, providing a foot type support below the foot of the ambulatory patient, providing one or more connection members between said seat area and said foot type support, and providing for securing said one or more connection members to the leg of said ambulatory patient devices and being facilitated by elevating the foot on the opposite leg.

### TECHNICAL FIELD

This invention relates to the general subject of providing a leg crutch to patients with lower leg difficulties which is conventionally provided by shoulder supporting crutches and similar devices as is facilitated by elevating the foot on the opposite leg.

### CROSS-REFERENCE TO RELATED APPLICATIONS

Not applicable.

STATEMENT REGARDING FEDERALLY SPONSORED RESEARCH OR DEVELOPMENT

Not applicable

REFERENCE TO A MICROFICHE APPENDIX

Not applicable

### BACKGROUND OF THE INVENTION

The field of this invention is that of providing a leg crutch to patients with lower leg difficulties which is conventionally provided by shoulder supporting crutches and similar devices as is facilitated by elevating the foot on the opposite leg.

Throughout recorded history damage to the legs has been treated with crutches which depended on taking support in the arm pits and walking in an awkward fashion. Recent advances by those skilled in the art have been to give more mobility by placing one's knee on a sort of high scooter and moving somewhat like a skate board or a scooter. The need to simply walk in a typical upright manner when a leg is compromised has always existed, but no solutions to this have been presented before.

### BRIEF SUMMARY OF THE INVENTION

The object of this invention is to provide a leg crutch for patients with compromised portions of their lower legs.

A second object of this invention is to provide a leg crutch which keeps all loading off the compromised leg without requiring the use of shoulder supporting crutches.

A third object of this invention is to provide a leg crutch that keeps all loading off the knee when the knee is compromised

Another object of the present invention is to provide a leg crutch while allowing the knee to flex to make the walking motion resemble uncompromised walking.

Another object of the invention is to allow the user to appear as normal as practical during the use of the devices, i.e. wearing regular clothes over a leg crutch.

### BRIEF DESCRIPTION OF THE DRAWINGS

FIG. 1 is a view of a man wearing the leg crutch of this invention.

FIG. 2 is a view of the leg crutch not being installed on a person.

### DETAILED DESCRIPTION OF THE INVENTION

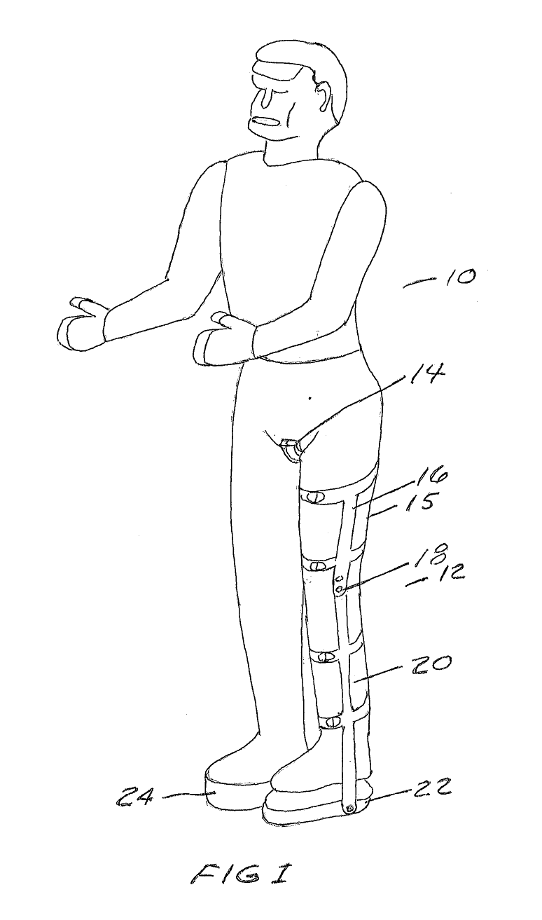

Referring now to FIG. 1, man 10 is shown wearing leg crutch 12 on his left leg 14.

Leg crutch 12 comprises a seat 15, an upper section 16, a pivot joint 18, a lower section 20, and a foot piece 22. As foot piece 22 is positioned several inches, i.e. four inches, below the left foot, an elevator section 24 is provided for the right shoe. This effectively makes the right leg and the left leg of the same length.

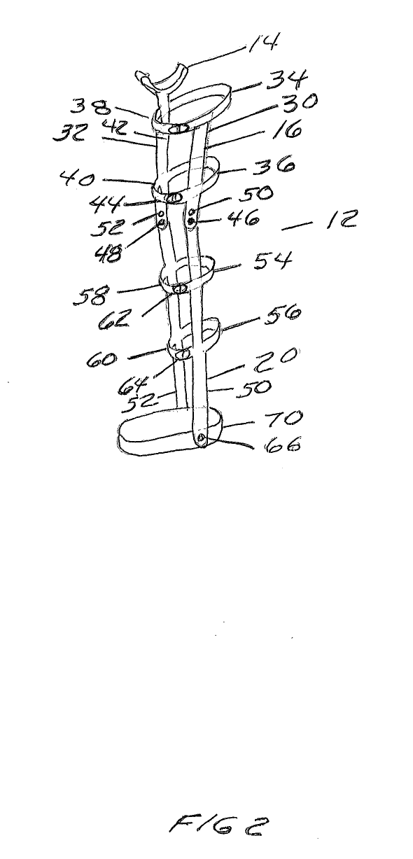

Referring now to FIG. 2, the leg crutch 12 is shown in better detail. Seat 15 resembles a bicycle seat and spreads the load out over the crotch of the man.

Upper section 16 comprises seat 15, vertical members 30 and 32, rear connecting members 34 and 36, straps 38 and 40 with adjustable buckles 42 and 44 respectively, pivot joints 46 and 48, and locking pins 50 and 52. Pivot joints 46 and 48 allow the knee to flex if the knee is not compromised and allows the man 10 to sit down even if his knee is compromised. The locking pins 50 and 52 can be inserted into appropriate holes to make the pivot joints 46 and 48 rigid if the man's knees are compromised and in need of reinforcement allowing the man to walk in a “stiff legged” fashion.

Referring again to FIG. 1, connecting members 34 and 36 and straps 38 and 40 snuggly secure the upper section 16 to the upper portion of the man's leg. The primary movement of the unit will be driven by the movement of the upper portion of the man's leg.

Referring again to FIG. 2, lower section 20 comprises vertical members 50 and 52, rear connecting members 54 and 56, straps 58 and 60 with buckles 62 and 64 respectively and ankle pin 66. If the knee is compromised, the pivot joints 46 and 48 will be locked and the connecting members 54 and 56 along with straps 58 and 60 will secure the knee from movement as the man walks. If the knee is not compromised, the pivot joints 46 and 48 will not be locked and the connecting members 54 and 56 along with straps 58 and 60 will allow the lower section of the leg to move the lower section 20 in a fashion closely resembling normal walking.

Ankle pin 66 attaches the foot type support 70 to the lower section 20 and may be freely pivoting, rigid or spring loaded. It is preferably spring loaded to give more of a feel of normal walking to the man and to facilitate his standing.

The leg crutch can be extended further up the torso of the ambulatory person when the problem is associated with the hip or when no control of the upper portion of the leg is seen. In this case the torso and compromised leg would move as one awkward stiff member as the other leg did the “walking”. Whereas this might seem undesirable, it would make the difference in some individuals working or not. For example, a chef simply cannot work on crutches whereas he or she may work in a stiff legged fashion on this type of leg crutch.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

That which is claimed is:

1. The method of providing a leg crutch for an ambulatory patient comprising:
providing a seat area to engage the crotch of the ambulatory patient,
providing a foot type support below the foot of the ambulatory patient,
providing one or more supporting connection members between said seat area and said foot type support, and
providing for securing said one or more connection members to the leg of said ambulatory patient.

2. The method of claim 1 further comprising a knee joint in said one or more connection members to provide bending flexibility generally in the area of the knee area of said ambulatory patient.

3. The method of claim 2, further comprising providing a lock for said knee joint which prevents said knee joint from bending.

4. The method of claim 1 further comprising an ankle joint allowing said foot type support to flex and facilitate walking.

5. The method of claim 1 further comprising an extension for the shoe of the leg not receiving the leg support allowing each of the legs to effectively have the same length.

6. The method of claim 1, wherein additional support is gained from the straps engaging said compromised leg.

7. The method of claim 1, wherein additional support is gained from the buttocks area.

8. The method of claim 1, providing means for securing said one or more connection members to the torso of said ambulatory person.

9. The method of facilitating support for a compromised leg of a person compromising
adding elevating soles to the shoe on the other leg to raise the bottom of the foot a first distance above the ground.

10. The method of claim 9, further comprising
providing a foot type support below the foot of the compromised leg approximately said first distance below the foot of said compromised leg, said foot type support being supported by the crotch of said person and not being supported by said foot.

11. The method of claim 10 further comprising a knee joint in said one or more connection members to provide bending flexibility generally in the area of the knee area of said ambulatory patient.

12. The method of claim 11, further comprising providing a lock for said knee joint which prevents said knee joint from bending.

13. The method of claim 10 further comprising an ankle joint allowing said foot type support to flex and facilitate walking.

14. The method of claim 10 further comprising an extension for the shoe of the leg not receiving the leg support allowing each of the legs to effectively have the same length.

15. The method of claim 10, wherein additional support is gained from the straps engaging said compromised leg.

16. The method of claim 10, wherein additional support is gained from the buttocks area.

17. The method of claim 10, providing means for securing said one or more connection members to the torso of said ambulatory person.
